(19) United States
(12) Patent Application Publication
(10) Pub. No.: US 2011/0097082 A1
(43) Pub. Date: Apr. 28, 2011

(54) APPARATUS, SYSTEMS, AND METHODS RELATED TO IMPROVED OPTICAL COMMUNICATION MODULES

(76) Inventor: Jaya BANDYOPADHYAY, San Jose, CA (US)

(21) Appl. No.: 12/604,573

(22) Filed: Oct. 23, 2009

(51) Int. Cl. H04J 14/00

(52) U.S. Cl. 398/45

(57) ABSTRACT

In one embodiment, a system includes a first cable interface module, a second cable interface module, and an interface card. The first cable interface module includes a signal recovery module. The second cable interface module does not include a signal recovery module. The interface card includes a first interface module and a second interface module. The first interface module is configured to be coupled to the first cable interface module at a first time and to the second cable interface module at a second time. The second interface module is configured to be coupled to the remaining cable of the first cable interface module and the second cable interface module.

### BACKGROUND

One or more embodiments relate generally to optical communication modules. More specifically, for example, one or more embodiments relate to apparatus, systems, and methods including optical communication modules defining different maximum operable optical cable lengths.

Known optical communication modules conform to various standards and support certain maximum operable data rates or bandwidths and maximum operable cable or connection lengths. Because known optical communication modules typically strictly conform to standards, little variety exists in the features of optical communication modules that conform to a specific standard. In other words, optical communication modules that conform to a given standard typically share all the properties of that standard: physical interface (e.g., dimensions, footprint, pin-out, or pattern of connectors), maximum operable data rates or bandwidths, and maximum operable cable or connection lengths. Users typically cannot, for example, adopt certain type or class of optical communication module to take advantage of the physical interface and produce cables compatible with that optical communication module having different maximum data rates or bandwidths and maximum cable or connection lengths.

Due to this lack of variety in properties of optical communication modules, users have limited flexibility to take advantage of certain aspects of a standard (e.g., data rate and physical interface dimensions) without accepting other properties that are not useful or necessary for that user (e.g., a maximum operable cable length that is greater than a cable length desired by that user). This leads undesirable effects such as increased cost because the user pays for features that are unnecessary for that user.

### SUMMARY

In one embodiment, a system includes a first cable interface module, a second cable interface module, and an interface card. The first cable interface module includes a signal recovery module. The second cable interface module does not include a signal recovery module. The interface card includes a first interface module and a second interface module. The first interface module is configured to be coupled to the first cable interface module at a first time and to the second cable interface module at a second time. The second interface module is configured to be coupled to the remaining cable interface module of the first cable interface module and the second cable interface module.

### BRIEF DESCRIPTION OF THE DRAWINGS

FIG. 1 is a schematic block diagram of a network including a group of access switches and a group of switch modules, according to an embodiment.

FIG. 2 is a schematic block diagram of a portion of the network illustrated in FIG. 1, according to an embodiment.

FIG. 3 is a schematic block diagram of cable interface module, according to an embodiment.

FIG. 4 is a schematic block diagram of another cable interface module, according to another embodiment.

FIG. 5A is a top perspective view schematic block diagram of an interface card and a group of cable interface module, according to an embodiment.

FIG. 5B is a side perspective view schematic block diagram of the interface card illustrated in FIG. 5A.

### DETAILED DESCRIPTION

One or more embodiments disclosed herein include cable interface modules, such as optical communication modules, that share a common physical interface (e.g., dimensions, footprint, pin-out, or connector pattern) and have different maximum operable data rates or bandwidths and maximum operable cable or connection lengths. For example, a first cable can include a cable interface module with a signal recovery module and a second cable can include a cable interface module without a signal recovery module. The cable interface module of the first cable and the cable interface module of the second cable can each have a connector with a common footprint. In other words, the cable interface module of the first cable and the cable interface module of the second cable each have connectors that can be received by (or receive) a common complementary connector.

The first cable can be longer than a maximum operable length of the second cable because the signal recovery module can reduce jitter, signal drift, and/or some other degradation of a signal transmitted via the first cable. Thus, the second cable can be used to operatively couple two devices such as, for example, computing devices, network switches, access switches, switch modules or stages within a multi-stage switch fabric, and/or chassis housing these or other devices when the two device are located within a distance one from another that is less than or equal to the length of the second cable (i.e., less than or equal to the maximum operable length of the second cable), and these devices can be connected with the first cable with the two devices are located within a distance one from another than is greater than the length of the second cable.

The combination of the two devices and a cable (either the first cable or the second cable) can be referred to as a system. A system using the second cable can reduce the cost of the system (e.g., the combined cost of the two devices and the second cable) as compared to the system with the first cable, because the signal recovery module is not used. The two devices, however, can be separated one from another by a distance greater than the maximum operable length of the second cable and be operatively coupled by the first cable. Thus, the cost of the system can be less for configurations in which the two device are located within a distance one from another that is less than or equal to the maximum operable length of the second cable, and more for configurations in which the two device are separated one from another by a distance that is greater than the maximum operable length of the second cable.

In one embodiment, a multi-stage switch fabric can include a group of edge devices through which computer servers can access the switch fabric, a first group of switch modules physically coupled to the edge devices, and a second group of switch modules physically coupled to switch modules from the first group of switches. In a first configuration, the first group of switch modules can be coupled to the edge devices using a first set of cables, and the second group of switch modules can be coupled to the first group of switch modules via a second set of cables. The cables in the first set of cables can exclude (or not include) signal recovery modules, and the cables in the second set of cables can include signal recovery modules. The edge devices and the first group of switch modules can be separated by a distance less than the maximum operable length of the first group of cables. The first group of switch modules and the second group of switch modules can be separated by a distance greater than the maximum operable length of the first group of cables and less than the maximum operable length of the second group of cables.

In a second configuration, the edge devices and the first group of switch modules can be separated by a distance greater than the maximum operable length of the first group of cables and less than the maximum operable length of the second group of cables. Additionally, the first group of switch modules and the second group of switch modules can be separated by a distance less than the maximum operable length of the first group of cables. Accordingly, in the second configuration the first group of switch modules can be coupled to the edge devices using the second set of cables, and the second group of switch modules can be coupled to the first group of switch modules via the first set of cables.

In some embodiments, some edge devices can be connected to switch modules from the first group of switch modules with cables from the first group of cables, and other edge devices can be connected to switch modules from the first group of switch modules with cables from the second group of cables. Similarly, some switch modules from the first group of switch modules can be connected to switch modules from the second group of switch modules with cables from the first group of cables, and other switch modules from the first group of switch modules can be connected to switch modules from the second group of switch modules with cables from the first group of cables. Thus, an edge device can be connected to one switch module from the first group of switch modules with a cable from the first group of cables and connected to another switch module from the first group of switch modules with a cable from the second group of cables. Furthermore, one switch module from the first group of switch modules can be connected to one switch module from the second group of switch modules with a cable from the first group of cables and connected to another switch module from the second group of switch modules with a cable from the second group of cables.

In some embodiments, in all other respects (i.e., other than changing the cables) the edge devices, first group of switch modules, and second group of switch modules can be identical (or substantially identical) in the first configuration and the second configuration. In other words, the first set of cables and the second set of cables can be interchangeable to provide the desired or appropriate reach to span the distance between the edge devices, the first group of switch modules, and/or the second group of switch modules. Furthermore, communication interface modules of the edge devices, the first group of switch modules, and the second group of switch modules can be compatible with each of the first set of cables and the second set of cables. Thus, cables from the second set of cables can be used when the edge devices, the first group of switch modules, and/or the second group of switch modules are separated by longer distances; and cables from the first set of cables can be used when the edge devices, the first group of switch modules, and/or the second group of switch modules are separated by shorter distances.

As used in this specification, the singular forms “a,” “an” and “the” include plural referents unless the context clearly dictates otherwise. Thus, for example, the term “a cable interface module” is intended to mean a cable interface module or multiple cable interface modules; and “a memory” is intended to mean one or more memories, or a combination thereof.

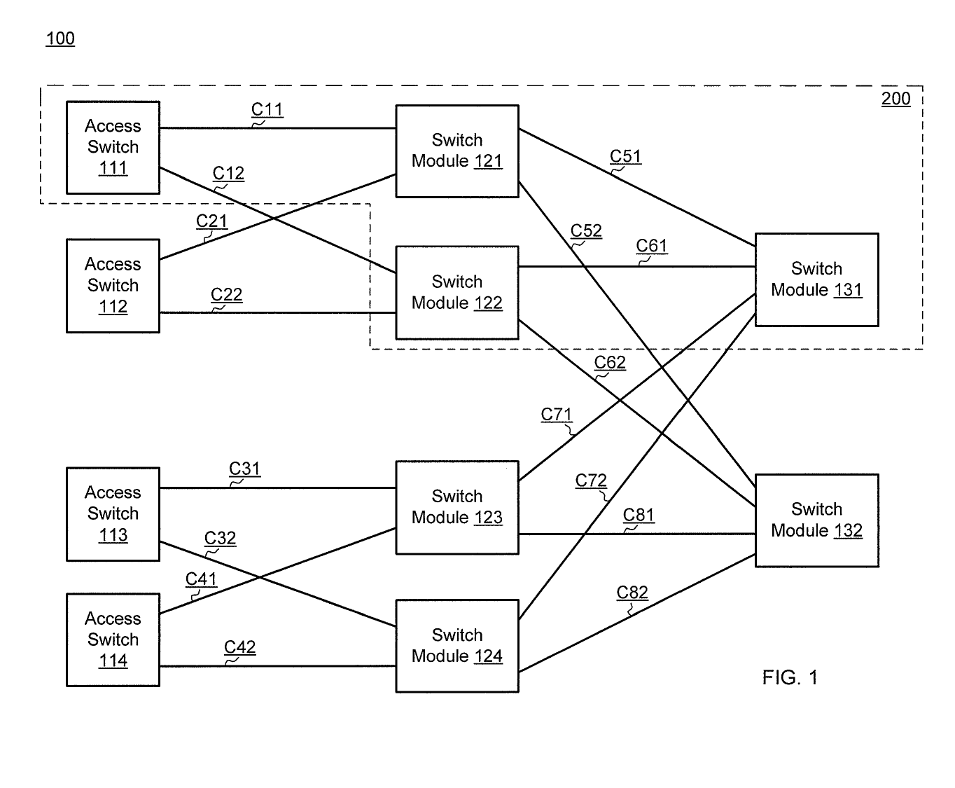

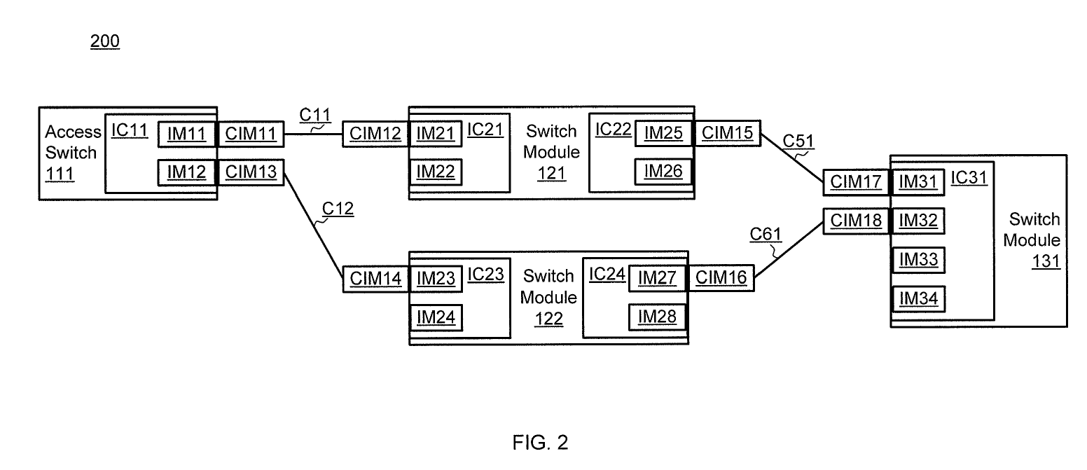

FIG. 1 is a schematic block diagram of network 100 including a group of access switches and a group of switch modules, according to an embodiment. Network 100 includes access switch 111, access switch 112, access switch 113, access switch 114, switch module 121, switch module 122, switch module 123, switch module 124, switch module 131, and switch module 132. Access switch 111 is operatively coupled to switch module 121 and switch module 122 via cables C11 and C12, respectively. Access switch 112 is operatively coupled to switch module 121 and switch module 122 via cables C21 and C22, respectively. Access switch 113 is operatively coupled to switch module 123 and switch module 124 via cables C31 and C32, respectively. Access switch 114 is operatively coupled to switch module 123 and switch module 124 via cables C41 and C42, respectively. Switch module 121 is operatively coupled to switch module 131 and switch module 132 via cables C51 and C52, respectively. Switch module 122 is operatively coupled to switch module 131 and switch module 132 via cables C61 and C62, respectively. Switch module 123 is operatively coupled to switch module 131 and switch module 132 via cables C71 and C81, respectively. Switch module 124 is operatively coupled to switch module 131 and switch module 132 via cables C72 and C82, respectively. Network portion 200 includes access switch 111, switch module 121, switch module 122, and switch module 131, and is discussed in more detail in relation to FIG. 2.

Network 100 is configured such that servers (not shown) operatively coupled to one or more of access switches 111, 112, 113, and 114 can communicate one with another via access switch 111, access switch 112, access switch 113, access switch 114, switch module 121, switch module 122, switch module 123, switch module 124, switch module 131, and switch module 132. Said differently, access switch 111, access switch 112, access switch 113, access switch 114, switch module 121, switch module 122, switch module 123, switch module 124, switch module 131, and switch module 132 are configured to define one or more communication paths through network 100. For example, a server (not shown) operatively coupled to access switch 111 can send a data packet addressed to a server (not shown) operatively coupled to access switch 114. Access switch 111 can forward the data packet to access switch 114 via one or more of switch module 121, switch module 122, switch module 123, switch module 124, switch module 131, and switch module 132. Access switch 114 can then forward the data packet to the server (not shown) operatively coupled to access switch 114. In some embodiments, one or more of access switch 111, access switch 112, access switch 113, and access switch 114 are configured to classify data packets received from servers (not shown) operatively coupled to access switch 111, access switch 112, access switch 113, or access switch 114, respectively.

Switch modules 121, 122, 123, 124, 131, and 132 can be configured to function within network 100 as a multi-stage switch fabric. In other words, switch modules 121, 122, 123, 124, 131, and 132 can be various stages of a multi-stage switch fabric. For example, switch modules 121, 122, 123, and 124 can be a first stage and third stage of a multi-stages switch fabric, and switch module 131 and 132 can be a second stage of that multi-stage switch fabric. In some embodiments, network 100 can include additional switch modules operatively coupled to switch modules 121, 122, 123, 124, 131, and 132 such that a multi-stage switch fabric includes more than three stages. For example, switch modules 121, 122, 123, 124, 131, and 132 can be operatively coupled to additional switch modules to form a five-stage switch fabric, a seven-stage switch fabric, or other higher-order multi-stage switch fabrics.

In some embodiments, a switch fabric defined by switch modules 121, 122, 123, 124, 131, and 132 can include a data plane in which data signals (e.g., data packets sent between servers (not shown) operatively coupled to one or more of access switches 111, 112, 113, and 114) are transmitted through the switch fabric, and a control plane in which control signals (e.g., routing information related to data signals and state information related to one or more stages or components of the switch fabric) are transmitted within the switch fabric.

In some embodiments, servers (not shown) operatively coupled to one or more of access switches 111, 112, 113, and 114 can communicate with access switches 111, 112, 113, and 114, respectively, via one protocol, and access switches 111, 112, 113, and 114 can communicate with switch modules 121, 122, 123, 124, 131, and 132 via another protocol. For example, servers (not shown) operatively coupled to one or more of access switches 111, 112, 113, and 114 can communicate with access switches 111, 112, 113, and 114, respectively, via an Ethernet protocol, and access switches 111, 112, 113, and 114 can communicate with switch modules 121, 122, 123, 124, 131, and 132 via a cell-based switching protocol (e.g., using fixed-length and/or variable-length cell switching protocols). In other words, in some embodiments access switches 111, 112, 113, and 114 can operate as gateways between servers (not shown) and/or other devices (e.g., network attached storage devices or storage area network devices not shown) communicating via one protocol and with switch modules 121, 122, 123, 124, 131, and 132 communicating via another protocol. In some embodiments, one or more of access switches 111, 112, 113, and 114 can be components (or parts) of a switch fabric defined by switch modules 121, 122, 123, 124, 131, and 132 and can be referred to as edge devices (or components) of that switch fabric.

In some embodiments, access switches 111, 112, 113, and 114 and switch modules 121, 122, 123, 124, 131, and 132 can each be located in a separate chassis independent from the chassis of the other of access switches 111, 112, 113, and 114 and switch modules 121, 122, 123, 124, 131, and 132. The chassis can include, for example, line cards, servers, and/or other network components or network devices. The chassis can be operatively coupled one to another via cables C11, C12, C21, C22, C31, C32, C41, C42, C51, C52, C61, C62, C71, C72, C81, and C82. These cables can be, for example, twisted-pair cables, single-mode fiber-optic cables, multi-mode fiber-optic cables, bundles of cables (e.g., multiple cables enclosed within a common physical housing), and/or combinations of such cables. In some embodiments, these cables can be multimode fiber-optic cables configured to support data throughput (or bandwidth) of 40 gigabits per second or 100 gigabits per second.

Access switches 111, 112, 113, and 114 and switch modules 121, 122, 123, 124, 131, and 132 can be general-purpose or purpose-specific computing devices and can each include, for example, one or more processors, one or more communication interfaces, and one or more memories. For example, each of access switches 111, 112, 113, and 114 can include twisted-pair Ethernet communication interfaces configured to be operatively coupled to one or more servers (not shown), and one or more fiber-optic Ethernet communication interfaces (or other fiber-optic communication interfaces such as, for example, a fixed-length cell switching interface or a Fiber Channel interface) configured to be operatively coupled to switch modules 121, 122, 123, and 124. Switch modules 121, 122, 123, and 124 can include one or more fiber-optic Ethernet communication interfaces (or other fiber-optic communication interfaces such as, for example, a fixed-length cell switching interface or a Fiber Channel interface) configured to be operatively coupled to access switches 111, 112, 113, and 114, and one or more fiber-optic Ethernet communication interfaces (or other fiber-optic communication interfaces such as, for example, Fiber Channel) configured to be operatively coupled to switch modules 131 and 132.

Additionally, access switches 111, 112, 113, and 114 and switch modules 121, 122, 123, 124, 131, and 132 can each include a processor operatively coupled to one or more communication interfaces such that the processor can be in communication with processors at the remaining of access switches 111, 112, 113, and 114 and switch modules 121, 122, 123, 124, 131, and 132 and one or more servers (not shown) operatively coupled to access switches 111, 112, 113, and 114 via the one or more communication interfaces. The processor can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages as Java™, C++, C, assembly, a hardware description language, or any other suitable programming language. A processor according to some embodiments includes media and computer code (also can be referred to as code) specially designed and constructed for the specific purpose or purposes.

The processor can also be a group of processors and/or processing (or execution) cores. For example, a processor can be a single physical processor having a group of processing cores. In some embodiments, a processor can be a group or cluster of processors such as a group of physical processors operatively coupled to a shared clock or synchronization signal, a shared memory, a shared memory bus, and/or a shared data bus. In other words, a processor can be a group of processors in a multi-processor computing device. In some embodiments, a processor can be a group of distributed processors (e.g., computing devices with one or more physical processors) operatively coupled one to another via a communications network such as network 100. Said differently, a processor can be a group of distributed processors in communication one with another via a communications network. In some embodiments, a processor can be a combination of such processors. For example, a processor can be a group of distributed computing devices, where each computing device includes a group of physical processors sharing a memory bus and each physical processor includes a group of processing cores.

Furthermore, a processor can be operatively coupled to one or more memories. A memory can be a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

Moreover, access switches 111, 112, 113, and 114 and switch modules 121, 122, 123, 124, 131, and 132 can include various sub-modules, components or computing devices such as ingress and egress ports including one or more ingress or egress queues, input and output modules, packet classification modules, routing engines or modules, switch controllers, and/or other sub-modules configured to manage or control network 100 and/or data transmitted via (or through) network 100. Such sub-module can be implemented as software modules hosted at one or more processors and resident within (or stored at) a memory operatively coupled to the one or more processors. Alternatively, such sub-module can be implemented as hardware modules such as application-specific integrated circuits and/or field-programmable gate arrays. In some embodiments, such sub-module can be implemented as a combination of software modules and hardware modules. In some embodiments, one or more such sub-module can be resident or hosted at access switches 111, 112, 113, and 114 or switch modules 121, 122, 123, 124, 131, and 132.

In some embodiments, access switches 111, 112, 113, and 114 are configured to classify data packets received from servers (not shown) operatively coupled to access switches 111, 112, 113, and 114, respectively, before forwarding the data packets to determine whether any processing is appropriate for the data packets. For example, access switches 111, 112, 113, and 114 can each include a packet classification module configured to classify data packets. In some embodiments, data packet classification can include determining whether a portion of a data packet satisfies a condition included in a policy such as, for example, a firewall policy, a routing policy, and/or an access control list (“ACL”). In some embodiments, a processing action (also referred to herein as an action) can be related to a condition in the policy, and access switches 111, 112, 113, and 114 are configured to execute (or perform) that action if the related condition is satisfied during packet classification. Actions can include, for example, modifying one or more parameters of a data packet, accessing a database (not shown) to determine routing information related to a data packet and/or destination of a data packet, dropping a packet, and/or other actions relative to the data packet. In some embodiments, data cells are defined based on data packets received at access switches 111, 112, 113, and 114, the data cells are forwarded through a switch fabric defined by switch modules 121, 122, 123, 124, 131, and 132. The data packets can be reassembled based on the data cell and can be forwarded, for example, to one or more of servers (not shown) operatively coupled to one or more of access switches 111, 112, 113, and 114.

In some embodiments, multiple actions can be related to a single condition. For example, if a condition is satisfied, access switch 111 can modify a time-to-live (“TTL”) value in a data packet received from a server (not shown) operatively coupled to access switch 111 and can access a database (not shown) to determine routing information related to or associated with the data packet. In some embodiments, an action can be dependent on another action defining a condition. Said differently, an action can be executed in response to a condition being satisfied by a data packet during packet classification, and that action can define a secondary (or supplemental) classification condition. If the secondary classification condition is satisfied, another action is executed. For example, a data packet received by access switch 114 from a server (not shown) operatively coupled to access switch 114 can be classified based on a condition (referred to as a primary classification condition, or primary condition) defining a longest prefix match of a destination Internet Protocol (“IP”) address of the packet. Access switch 114 can execute an action triggered by the primary condition where that action defines an additional, supplemental, or secondary classification condition (or secondary condition) such as a match of Transmission Control Protocol (“TCP”) flags in the data packet. Access switch 114 can further classify the data packet based on that secondary condition. In other words, if the TCP flags in the data packet satisfy the secondary condition defined in the action, access switch 114 can execute another action relative to the data packet. Thus, the result or outcome of packet classification with a primary classification condition can invoke or trigger packet classification with a secondary classification condition.

FIG. 2 is a schematic block diagram of portion 200 of network 100 illustrated in FIG. 1, according to an embodiment. Network portion 200 includes access switch 111, switch module 121, switch module 122, and switch module 131. Access switch 111 is operatively coupled to switch modules 121 and 122 via cables C11 and C12, respectively. Switch modules 121 and 122 are operatively coupled to switch module 131 via cables C51 and C61.

Access switch includes a communication interface defined by interface card IC11 that includes interface modules IM11 and IM12. Interface card IC11 is configured to provide a communication path between, for example, a processor (not shown) at access switch 111 and interface modules IM11 and IM12. For example, interface card IC111 can provide a physical interface (e.g., a bus) and medium access control such as multiplexing and de-multiplexing between a processor at access switch 111 and interface modules IM11 and IM112. Interface modules IM11 and IM12 are configured to transmit and receive data from and to, respectively, access switch 111. For example, interface modules IM11 and IM12 can define separate and independent communication interfaces to access switch 111. For example, interface modules IM11 and IM12 can each include a link-layer or network address and a physical-layer communications module.

Interface module IM11 and IM12 can include active and/or passive components. In some embodiments, interface modules IM11 and IM12 can include active components such as transistors, signal processing circuitry, and/or a processor. In some embodiments, interface modules IM11 and IM12 can include passive components such as resistors, capacitors, inductors, vias, and/or traces. In some embodiments, interface modules IM11 and IM12 can include passive components and active components.

Cable interface modules CIM11 and CIM13 are configured to be coupled to interface modules IM11 and IM12, respectively, and provide a signal translation interface between interface modules IM11 and IM12 and cables C11 and C12, respectively. For example, interface modules IM11 and IM12 can transmit and receive electrical signals and cables C11 and C12 can be fiber-optic cables. Cable interface modules CIM11 and CIM13 can include optical engines configured to convert the electric signals from interface modules IM11 and IM12 to optical signals that can be transmitted via cables C11 and C12, respectively. Similarly, the optical engines of cable interface modules CIM11 and CIM13 can be configured to convert the optical signals transmitted via fiber-optic cables C11 and C12 to electrical signals that can be received by interface modules IM11 and IM12, respectively. Accordingly, the optical engines of cable interface modules CIM11 and CIM13 can include electro-optical conversion modules such as, for example, solid-state or semiconductor lasers and/or optical components that define an optical path (e.g., lenses).

In some embodiments, optical engines can be unidirectional. For example, one interface module at an interface card can send data signals via a cable interface module and a cable, and another interface module at the interface card can receive data signals via a different interface module and a different cable.

Interface cards 1C21, IC22, IC23, IC24, and IC31 are configured substantially similar to interface card IC11. Interface modules IM21, IM22, IM23, IM24, IM25, IM26, IM27, IM28, IM31, IM32, IM33, and IM34 are configured substantially similar to interface modules IM11 and IM12. Cable interface modules CIM12, CIM14, CIM15, CIM16, CIM17, and CIM18 are configured substantially similar to cable interface modules CIM11 and CIM13.

For example, a first server (not shown) operatively coupled to access switch 111 can send a data packet to a second server (not shown) operatively coupled to access switch 111 as follows. The first server can send the data packet (e.g., signals representing the data packet) to access switch 111. Access switch 111 can receive the data packet and perform any processing related to that data packet (e.g., data packet classification, filtering, and/or replication) and define a group of data cells that represent the data packet. In other words, the contents (e.g., payload) of the data packet and/or data related to the contents of a data packet (e.g., data packet type, protocol identifier, protocol directives such as flags or parameters, TTL values, or other header information) can be separated into fixed-length cells for transmission via a switch fabric defined in part by switch modules 121, 122 and 131.

Each data cell can be represented, for example, by electrical signals and can be provided to interface module IM11 at interface card IC11. The electrical signals for a data cell can then be provided to cable interface module CIM11 and cable interface module CIM11 can define optical signals that represent the electrical signals. The optical signals can then be transmitted to cable interface module CIM12 via cable C11.

At cable interface module CIM12, the optical signals can be converted to electrical signals. Those electrical signals can be received at interface module IM21 of interface card IC21 at switch module 121. Switch module 121 can process the data cell represented by the electrical signals before providing electrical signals representing that data cell to interface module IM25 of interface card IC22. The electrical signals can then be provided to cable interface module CIM15 and cable interface module CIM15 can define optical signals that represent the electrical signals. The optical signals can then be transmitted to cable interface module CIM17 via cable C51.

At cable interface module CIM17, the optical signals can be converted to electrical signals. Those electrical signals can be received at interface module IM31 of interface card IC31 at switch module 131. Switch module 131 can process the data cell represented by the electrical signals before providing electrical signals representing that data cell to interface module IM32 of interface card IC31. The electrical signals can then be provided to cable interface module CIM18 and cable interface module CIM18 can define optical signals that represent the electrical signals. The optical signals can then be transmitted to cable interface module CIM16 via cable C61.

At cable interface module CIM16, the optical signals can be converted to electrical signals. Those electrical signals can be received at interface module IM27 of interface card IC24 at switch module 122. Switch module 122 can process the data cell represented by the electrical signals before providing electrical signals representing that data cell to interface module IM23 of interface card IC23. The electrical signals can then be provided to cable interface module CIM14 and cable interface module CIM14 can define optical signals that represent the electrical signals. The optical signals can then be transmitted to cable interface module CIM13 via cable C12.

At cable interface module CIM13, the optical signals can be converted to electrical signals. Those electrical signals can be received at interface module IM12 of interface card IC11 at switch module 111. Switch module 111 can process the data cell represented by the electrical signals before providing electrical signals representing that data cell to the second server.

In some embodiments, cable interface modules can be integrated portions of cables. In other words, a cable interface module can be permanently coupled to a cable. For example, cable interface module CIM11 can be fixed to one end of cable C11 and cable interface module CIM12 can be fixed to the other end of cable C11. Access switch 111 can be operatively coupled to switch module 121 by coupling (e.g., plugging or connecting) cable interface module CIM11 with interface module IM11 and coupling cable interface module CIM12 with interface module IM21. In some embodiments, cable interface modules can be removably coupled to cables. Said differently, cables can be attached and separated from cable interface modules. For example, cable interface modules CIM13 and CIM14 can be removably couplable to cable C12. Access switch 111 can be operatively coupled to switch module 122 by first coupling (e.g., plugging or connecting) cable interface module CIM13 with interface module IM12 and cable interface module CIM14 with interface module IM23. Cable C12 can then be coupled at one end with cable interface module CIM13 and coupled at the other end with cable interface module CIM14. In some embodiments, a cable can have a cable interface module permanently coupled at one end of the cable and can be removably couplable to a cable interface module at the other end of the cable.

The electrical, optical, or electro-optical path or connection defined by interface modules, cable interface modules, and a cable can have a maximum supported or operable length. In other words, based at least in part on the interface modules, the cable interface modules, and the cable defining a connection between two devices (e.g., a first switch module and a second switch module) can transmit and/or receive (or support) electrical and/or optical signals for a maximum propagation distance after which the signals are sufficiently degraded that the information included in those signals cannot be reliably recovered, detected, and/or estimated from those signals received at distances greater than the maximum propagation distance.

The maximum propagation, operable, or supported distance can vary based on the components (e.g., integrated circuits (“ICs”), printed circuit board (“PCB”) traces, lenses and other optical elements, physical connectors, solder joints, cable materials, signal power, etc.) and properties of the interface modules, the cable interface modules, and the cable. Such components and properties affect various properties of signals propagating or traversing an electrical, optical, or electro-optical path or connection. For example, such components and properties can affect parameters including: inter-symbol interference, modal partition noise, relative noise, modal noise, fiber attenuation, signal drift and jitter. These parameters are typically limiting factors in a maximum propagation, operable, or supported distance because they define physical limitation on the distance a signal can propagate through an electrical, optical, or electro-optical path or connection before the information included in the signal cannot be recovered from the signal.

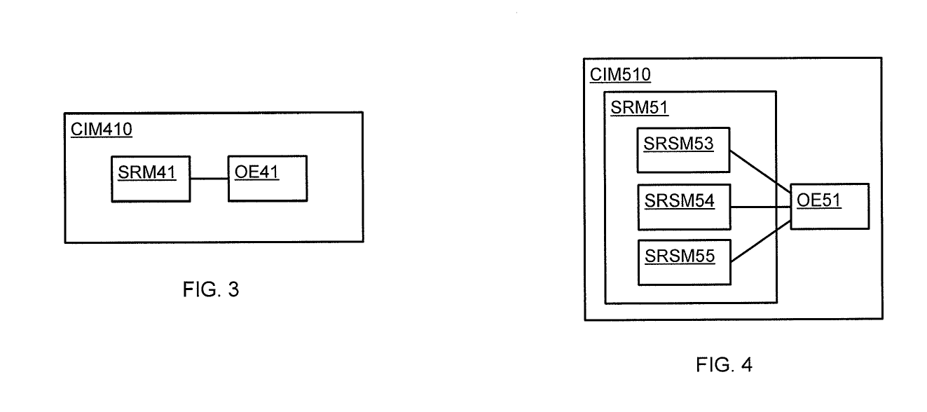

In some embodiments, a signal recovery module such as a clock recovery module, a data recovery module, and/or a clock-and-data recovery (“CDR”) module can be included in a cable interface module to improve or extend a maximum propagation, operable, or supported distance of an electrical, optical, or electro-optical path or connection compared to that electrical, optical, or electro-optical path or connection without the signal recovery module. Signal recovery can reduce, for example, signal drift and jitter. For example, FIG. 3 is a schematic block diagram of cable interface module, according to an embodiment, and FIG. 4 is a schematic block diagram of another cable interface module, according to another embodiment.

As illustrated in FIG. 3 cable interface module includes CIM410 includes signal recovery module SRM41 operatively coupled to optical engine OE41. Signal recovery module SRM41 can receive signals from an interface module, perform signal recovery such as, for example, CDR on those signals and provide the recovered (or processed) signals to optical engine OE41 for transmission via a fiber-optic cable. Similarly, optical engine OE41 can receive optical signals and convert those optical signals to electrical signals. Signal recovery module SRM41 can receive the electrical signals, perform signal recovery such as, for example, CDR on those signals and provide the recovered (or processed) signals to an interface module.

As illustrated in FIG. 4 cable interface module includes CIM510 includes signal recovery module SRM51 includes a group of signal recovery sub-modules SRSM53, SRSM54, and SRSM55 operatively coupled to optical engine OE51. Signal recovery module SRM51 can receive signals from an interface module in group of channels, perform signal recovery such as, for example, CDR on each channel of signals separately at signal recovery sub-modules SRSM53, SRSM54, and SRSM55 and provide the recovered (or processed) signals to optical engine OE51 for transmission via a fiber-optic cable. Similarly, optical engine OE51 can receive optical signals within a plurality of channels (e.g., channels in a multi-mode fiber-optic cable) and convert the optical signals in those channels to electrical signals in a group of channels. Signal recovery module SRM51 can receive the electrical signals, and perform signal recovery such as, for example, CDR on each channel of signals separately at signal recovery sub-modules SRSM53, SRSM54, and SRSM55 and provide the recovered (or processed) signals in the group of channels to an interface module. In other words, signals within various communication channels can be processed at a signal recovery module at a group of separate and independent signal recovery sub-modules. Said differently, multiple channels of data signals can be independently processed at a signal recovery module to, for example, increase a data throughput of the signal recover module. In some embodiments, a data channel can be unidirectional. For example, one channel can be a send channel and another channel can be a receive channel.

In some embodiments, a signal recovery module and an optical engine can be co-located at (or on or within) a single substrate. For example, an optical engine and a signal recovery module can share a common silicon substrate. In other words, electronic circuitry and optical elements included in an optical engine and a signal recovery module can be fabricated on a silicon die and housed in an integrated circuit chip. In some embodiments, a signal recover module can be fabricated on a silicon die and the optical engine can be fabricated on another silicon die. The two silicon dies can then be combined in a single integrated circuit (e.g., within an integrated circuit package substrate) to form a multi-chip module (“MCM”).

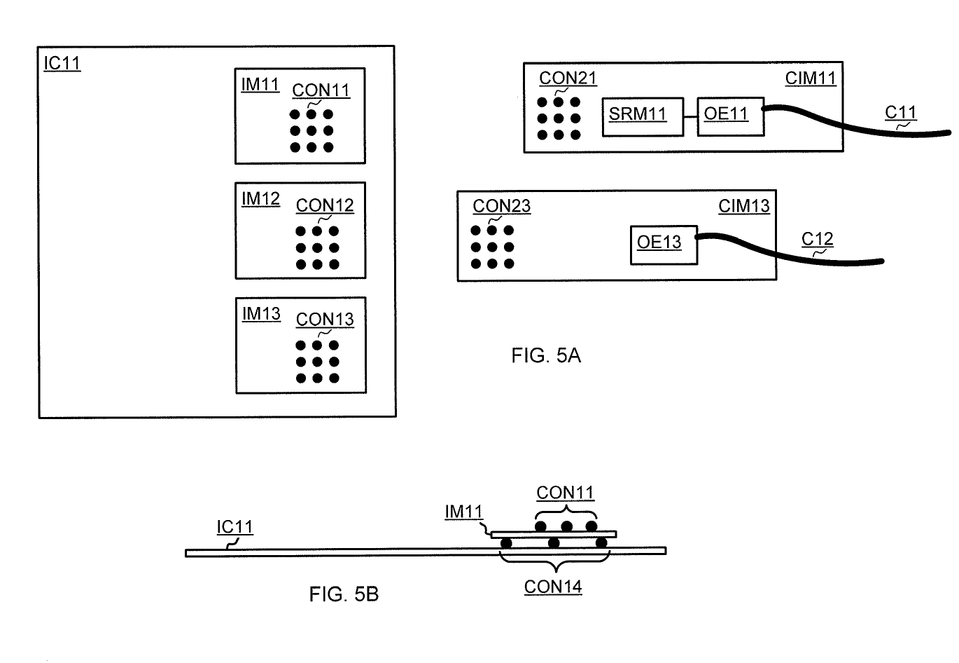

FIG. 5A is a schematic block diagram of interface card IC11 and cable interface module CIM11 and CIM13, according to an embodiment. Interface card IC11 includes interface modules IM11, IM12, and IM13 and connectors CON11, CON12, and CON13. Interface module IM11 is operatively coupled to connector CON11; interface module IM12 is operatively coupled to connector CON12; interface module IM13 is operatively coupled to connector CON13. Cable interface module CIM11 includes signal recovery module SRM11, optical engine OE11, and connector CON21. Cable C11 is operatively coupled to optical engine OE11. Cable interface module CIM13 includes optical engine OE13, and connector CON23. Cable C12 is operatively coupled to optical engine OE13.

As discussed above, interface module IM11, IM12, and IM13 can include active and/or passive components. In some embodiments, interface modules IM11, IM12, and IM13 can include active components such as transistors, signal processing circuitry, and/or one or more processors. In some embodiments, interface modules IM11, IM12, and IM13 can include passive components such as resistors, capacitors, inductors, vias, and/or traces. In some embodiments, interface modules IM11, IM12, and IM13 can include passive components and active components. For example, FIG. 5B is a side perspective view schematic block diagram of the interface card illustrated in FIG. 5A. As illustrated in FIG. 5B, interface module IM11 can be a substrate or package that is configured to be coupled on one side to connector CON14 on interface card IC11 and to include connector CON11 on another side. Interface module IM11 can, for example, include traces or vias connecting connector CON14 on interface card IC11 to connector CON11. In some embodiments, interface module IM11 can include active and/or passive components configured to modify or condition signals passed between connectors CON11 and CON14 via interface module IM11.

FIG. 5B shows one example of an interface card and other arrangements are possible such as, through hole connections, snap-fit connections, lockably couplable connections, and/or other connections between an interface card, an interface module, and a cable interface module. Additionally, a connector such as CON11 can be a separate module (e.g., a lockably couplable connection module) separable from an interface module. In some embodiments, an interface module can have a first portion and a second portion that are couplable. For example, the first portion can be operatively coupled to the line card and can include a connector, and the second portion can be operatively coupled to the cable interface module and can include a connector corresponding to the connector of the first portion. In other words, with reference to FIG. 5A, a first portion of interface module IM11 can be coupled to interface card IC11 and can include connector CON11. A second portion of interface module IM11 (not shown) that is configure to have a complementary or lockable fit with the first portion of interface module IM11 can be coupled to cable interface module CIM11 and can include connector CON21. Cable interface module CIM11 and interface card IC11 can be operatively coupled by coupling the first portion of interface module IM11 with the second portion of interface module IM11 (not shown).

Connectors CON11, CON12, CON13, CON21, and CON23 each define a footprint or pattern. The footprints or patterns of CON11, CON12, and CON13 are compatible with the footprints or patterns of connectors CON21 and CON23. In other words, connectors CON21 and CON23 are complementary to connectors CON11, CON12, and CON13. Said differently, connectors CON21 and CON23 are configured to fit with or receive (or be received by) connectors CON11, CON12, and CON13. Thus, cable interface module CIM11 can be operatively coupled to interface module IM11, interface module IM12, or interface module IM13 via connector CON21 and connector CON11, connector CON12, or connector CON13, respectively. Similarly, cable interface module CIM13 can be operatively coupled to interface module IM11, interface module IM12, or interface module IM13 via connector CON23 and connector CON11, connector CON12, or connector CON13, respectively. Said differently, either of cable interface modules CIM11 and CIM13 can be operatively coupled to any of interface modules IM11, IM12, and IM13.

As discussed above, cable interface module CIM11 includes signal recovery module SRM11, and cable interface module CIM13 does not include a signal recovery module. For example, cable interface module CIM11 can include signal recovery module SRM 11 to increase a maximum operable length of an electrical, optical, or electro-optical path or connection including cable interface module CIM11 and cable C11. Thus, cable interface module CIM11 and cable C11 can be used to couple interface card IC11 (or an access switch or switch module including interface card IC11) to a first interface card separated from interface card IC11 by a distance greater than a distance by which interface card IC11 is separated from a second interface card coupled to interface card IC11 via cable interface module CIM13 and cable C12. Said differently, cable interface modules CIM11 and CIM13 are each compatible with each of connectors CON11, CON12, and CON13 and cable interface module CIM11 can improve a maximum operable length by comparison with cable interface module CIM13.

In some embodiments, methods, systems and apparatus described herein can be useful to increase the density of connections or links available at switch module chassis within a multi-stage switch fabric, and to provide diversity in the lengths of the connections or links between the switch module chassis within the multi-stage switch fabric. In one embodiment, the switch module chassis include interface modules that are interoperable with (e.g., can be connected or coupled to) either of two types of cable interface modules. Said differently, each interface module of the interface card within a switch module chassis can be compatible or configured to receive or be connected to cable interface modules of the first type and cable interface modules of the second type. In other words, cable interface modules of the first type and cable interface modules of the second type are interchangeable with respect to the interface modules of the interface cards within the switch module chassis of the multi-stage switch fabric.

Cable interface modules of the first type of cable interface module can include an optical engine within the cable interface modules. As discussed above, the optical engine can receive electrical signals and send optical signals defined in response to the electrical signals. In other words, the optical engine in each cable interface module can convert the electrical signals into corresponding optical signals. The optical signals can be transmitted via one or more optical fibers (e.g., single-mode optical fibers or multi-mode optical fibers) to a receiving cable interface module. The receiving cable interface module can include an optical engine configured to receive the optical signals and convert the optical signals into electrical signals and provide the electrical signals to an interface module of an interface card included within a switch module chassis within the multi-stage switch fabric.

Cable interface modules of the second type of cable interface module can include and optical engine and a signal recovery module within the cable interface modules. As discussed above, the signal recovery module can include: clock and/or data recovery processors, modules, or devices; retiming processors, modules, or devices; and/or other signal recovery functionality. In some embodiments, the signal recovery module can include discrete chips, silicon dies, or circuits on a shared silicon die.

In some embodiments, a custom or reduced-size optical engine can be used within cable interface modules of the second type (and cable interface modules of the first type) such that the physical dimensions of a cable interface module do not exceed those that provide a desired density of cable interface modules that can be connected to an interface card. For example, the physical dimensions of a CXP optical module (a cable interface module) can provide the desired density of cable interface modules for an interface card or a switch module chassis. Said differently, the physical dimensions of a CXP optical module can allow for a desired number of cable interface modules conforming to the CXP optical module physical dimensions to fit on an interface card. However, a standard optical engine of a CXP optical module does not allow sufficient space within the CXP optical module physical dimensions for one or more signal recovery modules. In some embodiments, a multi-chip module (“MCM”) including an optical module and one or more signal recovery modules can be used to manufacture a cable interface module including a signal recovery module that fits within (or can be included within) a desired package.

By using a purpose-built (or custom) reduced-size optical engine, the reduced-size optical engine and a signal recovery module can be included within the package (i.e., the physical dimensions) of a CXP optical module. In some embodiments, the reduced-size optical engine and signal recovery module can be included within a package of a modified cable interface module with a footprint that is smaller than the footprint of a CXP optical module (e.g., the footprint of a standard package of a CXP optical module).

For example, a the footprint of a CXP optical module can be at least one and a half time larger than the footprint of a modified cable interface module having a package including the reduced-size optical engine alone or the reduced-size optical engine and the signal recovery module. Said differently, the footprint of the modified cable interface module can have dimensions that are two-thirds (or less) of the dimensions of the footprint of the CXP optical module. Thus, the density of connectors on a line card including interface modules and connectors configured to be compatible with (or connect to) the modified cable interface modules can be greater than the density of connectors on that same line card if configured to receive or be compatible with CXP optical modules. In other words, the line card configured to be compatible with the modified cable interface modules can include at least one and a half times as many connectors (the connector density) as a line card having the same dimensions that is configured to be compatible with CXP optical modules.

The signal recovery module can increase the maximum operable length of cables operatively coupled to cable interface modules of the second type with respect to the maximum operable length of cables operatively coupled to cable interface modules of the first type. Said differently, cable interface modules of the second type can support longer cables than the cables supported by cable interface modules of the first type. In this context, to support a cable means that a cable interface module can produce a signal (e.g., an optical signal) including some data and that after propagating across the supported cable can be received such that the data can be interpreted from the signal.

Because each type of cable interface module supports a different maximum operable length and is compatible with the interface modules of the interface cards within the switch module chassis of the multi-stage switch fabric, cable interface modules can be selected from the first type and the second type for each particular link between switch module chassis within the multi-stage switch fabric. For example, one switch module chassis can be operatively coupled to two separate and remote switch module chassis within the multi-stage switch fabric. One of the remote switch module chassis can be located 90 meters from the switch module chassis, and the other remote switch module chassis can be located 115 meters from the switch module chassis. The maximum operable length of cables operatively coupled to cable interface modules of the first type can be 100 meters, and the maximum operable length of cables operatively coupled to cable interface modules of the second type can be 120 meters. Thus, the switch module chassis can be coupled to the remote switch module chassis that is 90 meters away through a cable operatively coupled to cable interface modules of the first type. The switch module chassis can be coupled to the remote switch module chassis that is 115 meters away through a cable operatively coupled to cable interface modules of the first second.

In some embodiments, more than two types of cable interface modules can exist, providing more options and choices (or finer selection) of appropriate cable length within the switch fabric network. For example, multiple classes of signal recovery modules can be used in cable interface modules to support various lengths of cables. More specifically, for example, the classes of signal recovery modules can provide different amounts or degrees of levels of signal recovery and can each be related to a different maximum operable length.

The interoperability between the cable interface modules of the first type and second type can provide reduced costs in the multi-stage switch fabric. The cable interface modules of the first type are typically less exsensive than the cable interface modules of the second type, because cable interface modules of the first type do not include a signal recovery module. Furthermore, the cable interface modules can be less expensive due to less demanding requirements on, for example, optical engine size or dimensions. Thus, the switch module chassis (or the interface cards and/or interface modules therein) can be common or similar within the multi-stage switch fabric, the less expensive cable interface modules of the first type can be used where the maximum operable length afforded by cable interface modules of the first type is sufficient (e.g., is sufficiently long) for a connection or link, and the more expensive cable interface modules of the second type can be used where the maximum operable length afforded by cable interface modules of the second type is insufficient (e.g., not sufficiently long) for a connection or link.

While various embodiments have been described above, it should be understood that they have been presented by way of example only, not limitation, and various changes in form and details may be made. Additionally, embodiments described in relation to software modules are generally applicable to hardware modules; and embodiments described in relation to hardware modules are generally applicable to software modules. Any portion of the apparatus and/or methods described herein may be combined in any combination, except mutually exclusive combinations. The embodiments described herein can include various combinations and/or sub-combinations of the functions, components and/or features of the different embodiments described. For example, apparatus, systems, and methods discussed in relation to cable or maximum operable length can be applicable to increased bandwidth or data throughput in cables. Furthermore, each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A system, comprising:
a first cable interface module including a signal recovery module;
a second cable interface module not including a signal recovery module; and
an interface card including a first interface module and a second interface module, the first interface module configured to be coupled to the first cable interface module at a first time and the second cable interface module at a second time, the second interface module configured to be coupled to a remaining cable interface module of the first cable interface module and the second cable interface module.

2. The system of claim 1, wherein the signal recovery module is housed in a substrate including an optical engine.

3. The system of claim 1, wherein the interface card is associated with a stage of a multi-stage switch fabric.

4. The system of claim 1, wherein:
the first cable interface module is configured to provide a data throughput of at least 40 gigabits per second via a multimode optical fiber operatively coupled to the first cable interface module; and
the second cable interface module is configured to provide a data throughput of at least 40 gigabits per second via a multimode optical fiber operatively coupled to the second cable interface module.

5. The system of claim 1, wherein:
the first cable interface module is configured to provide a data throughput of at least 100 gigabits per second via a multimode optical fiber operatively coupled to the first cable interface module; and
the second cable interface module is configured to provide a data throughput of at least 100 gigabits per second via a multimode optical fiber operatively coupled to the second cable interface module.

6. The system of claim 1, wherein:
the first cable interface module includes a connector defining a footprint; and
the second cable interface module includes a connector defining a footprint substantially equal to the footprint defined by the connector of the first cable interface module.

7. The system of claim 1, wherein:
the first cable interface module includes a connector;
the second cable interface module includes a connector;
the interface card includes a first connector operatively coupled to the first interface module, the first connector being configured to complementary fit with the connector of the first cable interface module and the connector of the second cable interface module; and
the interface card includes a second connector operatively coupled to the second interface module, the second connector being configured to complementary fit with the connector of the first cable interface module and the connector of the second cable interface module.

8. The system of claim 1, wherein:
the first cable interface module defines a first supported optical fiber length; and
the second cable interface module defines a second supported optical fiber length less than the first supported optical fiber length.

9. The system of claim 1, wherein the signal recovery module includes a clock-and-data recovery module.

10. The system of claim 1, wherein the signal recovery module includes a plurality of independent signal recovery submodules.

11. The system of claim 1, wherein:
the first cable interface module has a footprint having dimensions that are less than two-thirds of the corresponding dimensions of the footprint of a standard CXP optical module; and
the second cable interface module has a footprint having dimensions that are less than two-thirds of the corresponding dimensions of the footprint of a standard CXP optical module.

12. An apparatus, comprising:
an interface card having:
a first interface module;
a second interface module;
a first connector defining a footprint; and
a second connector defining a footprint substantially equal to the footprint of the first connector,
the first interface module operatively coupled to the first connector, the first connector being configured to complementary fit with a first cable interface module including a signal recovery module and with a second cable interface module without of a signal recovery module,
the second interface module operatively coupled to the second connector, the second connector being configured to complementary fit with the first cable interface module and with the second cable interface module.

13. The apparatus of claim 12, wherein:
the first interface module includes a signal recovery module; and
the second interface module does not include a signal recovery module.

14. The apparatus of claim 12, wherein the interface card is associated with a stage of a multi-stage switch fabric.

15. The apparatus of claim 12, wherein the signal recovery module is housed in a substrate including an optical engine.

16. The apparatus of claim 12, wherein:
the first interface module defines a plurality of data channels; and
the second interface module defines a plurality of data channels.

17. The apparatus of claim 12, wherein:
the first cable interface module is coupled to a first optical fiber having a maximum operable length, the maximum operable length of the first optical fiber defined in part by the first cable interface module; and
the second cable interface module is coupled to a second optical fiber having a maximum operable length, the maximum operable length of the second optical fiber defined in part by the second cable interface module, the maximum operable length of the second optical fiber being less than the maximum operable length of the first optical fiber.

18. The apparatus of claim 12, further comprising:
the first cable interface module, the first cable interface module being configured to provide a data throughput of at least 40 gigabits per second via a multimode optical fiber operatively coupled to the first cable interface module; and
the second cable interface module, the second cable interface module being configured to provide a data throughput of at least 40 gigabits per second via a multimode optical fiber operatively coupled to the second cable interface module.

19. The apparatus of claim 12, further comprising:
the first cable interface module, the first cable interface module being configured to provide a data throughput of at least 100 gigabits per second via a multimode optical fiber operatively coupled to the first cable interface module; and
the second cable interface module, the second cable interface module being configured to provide a data throughput of at least 100 gigabits per second via a multimode optical fiber operatively coupled to the second cable interface module.

20. A system, comprising:
a first interface card disposed within a first chassis;
a second interface card disposed within a second chassis;
a third interface card disposed within a third chassis;
a first optical fiber having a length and having a connector connected to the first interface card and a connector connected to the second interface card, the connectors of the first optical fiber each has a signal recovery module; and
a second optical fiber having a length and having a connector connected to the first interface card and a connector connected to the third interface card, the connectors of the second optical fiber each have no signal recovery module, the length of the first optical fiber being greater than the length of the second optical fiber.

21. The system of claim 20, wherein:
the first optical fiber has a maximum operable length, the maximum operable length of the first optical fiber defined in part by the connectors of the first optical fiber; and
the second optical fiber has a maximum operable length, the maximum operable length of the second optical fiber defined in part by the connectors of the second optical fiber, the maximum operable length of the second optical fiber being less than the maximum operable length of the first optical fiber.

22. The system of claim 20, wherein:
the first interface card has physical dimensions and a connector density that is at least one and a half times greater than a connector density of an interface card having the physical dimensions of the first interface card and configured to be compatible with CXP optical modules;
the second interface card has physical dimensions and a connector density that is at least one and a half times greater than a connector density of an interface card having the physical dimensions of the second interface card and configured to be compatible with CXP optical modules; and
the third interface card has physical dimensions and a connector density that is at least one and a half times greater than a connector density of an interface card having the physical dimensions of the third interface card and configured to be compatible with CXP optical modules.
